(19) United States
(12) Patent Application Publication
(10) Pub. No.: US 2026/0142210 A1
(43) Pub. Date: May 21, 2026

(54) FUEL CELL PLATE

(71) Applicant: L'Air Liquide, Societe Anonyme pour l'Etude et l’Exploitation des Procedes Georges Claude, Paris (FR)

(72) Inventors: Johan ANDRE, Sassenage (FR); Denis SIRAC, Sassenage (FR)

(73) Assignee: L'Air Liquide, Societe Anonyme pour l'Etude et l’Exploitation des Procedes Georges Claude, Paris (FR)

(21) Appl. No.: 18/291,315

(22) PCT Filed: Jun. 22, 2022
(86) PCT No.: PCT/EP2022/067048

§ 371 Date: Jan. 23, 2024

(30) Foreign Application Priority Data
Jul. 23, 2021 (FR) FR 2108028

(51) Int. Cl. H01M 8/1006; H01M 8/04007; H01M 8/04082; H01M 8/04701; H01M 8/04746; H01M 8/2483

(52) U.S. Cl. CPC H01M 8/1006; H01M 8/04074; H01M 8/04208; H01M 8/04708; H01M 8/04753; H01M 8/2483

(57) ABSTRACT

The invention concerns a fuel cell plate arranged in a vertical plane when in a usage position, the plate comprising a reagent outlet manifold port, a cooling face and a reactive face forming a reagent circuit with an outlet leading into a reagent discharge port; the vertical usage position of the plate defining a vertical longitudinal direction between an upper edge and a lower edge of the plate; the discharge port extending along the vertical longitudinal direction between an upper end and a lower end; and the outlet manifold port extending along the vertical longitudinal direction between an upper end and a lower end and comprising an upper inner edge and a lower inner edge.

### CROSS REFERENCE TO RELATED APPLICATIONS

This application is a § 371 of International PCT Application PCT/EP 2022/067048, filed Jun. 22, 2022, which claims the benefit of FR 2108028, filed Jul. 23, 2021, both of which are herein incorporated by reference in their entireties.

### FIELD OF THE INVENTION

The present invention concerns a fuel cell plate, a cell module for a fuel cell comprising such a plate, and a fuel cell comprising such a cell module. The invention is particularly advantageously applicable to fuel cells in which the cell modules comprise plates extending in a vertical plane when the cell is in the usage position.

### BACKGROUND OF THE INVENTION

In a manner known per se, a fuel cell is an electrochemical device, which makes it possible to convert chemical energy into electrical energy using a fuel, generally dihydrogen, and an oxidant, generally dioxygen or a gas containing it, such as air, the product of the reaction being water together with a release of heat and generation of electricity.

In a known configuration, the cell modules and hence the plates are oriented vertically when the cell is in a usage position, i.e., when the plane of the plates is vertical. In this type of configuration, depending on the usage conditions of the cell modules, problems may occur with the management of water in the cell (water-saturated Electrode Membrane Assembly, excess of water in the reagent ducts, poor air supply etc.).

Water management is crucial and requires choices relating to the geometry of the manifolds and their arrangement, depending on the orientation of the cell.

It is thus important to promote the discharge of liquid water (reaction product) outside the cell modules. In particular, the position of the manifolds relative to the active surface may be limited to an unfavorable position with respect to drainage by gravity, without it being possible to introduce a motive force to discharge the water thus produced (e.g., recirculation pump, pressure gradient, purges etc.).

### SUMMARY OF THE INVENTION

In certain embodiments, the present invention aims to effectively remedy these drawbacks by proposing a plate for a fuel cell of the proton-exchange membrane type, the plate being arranged in a vertical plane when in a usage position; the plate comprising a reactive face and a cooling face opposite one another; the reactive face being intended to face an Electrode Membrane Assembly and being equipped with reliefs and recesses forming a reagent circuit for the circulation of a reactive fluid; the reagent circuit comprising an inlet which opens into a reagent distribution port; the plate comprising a reagent inlet manifold port separate from the reagent distribution port; the reagent inlet manifold port being arranged to supply reagent to the inlet of the reagent circuit via an inlet passage which brings the reagent inlet manifold port into fluidic communication with the reagent distribution port; the reagent circuit comprising an outlet which opens into a reagent discharge port; the plate comprising a reagent outlet manifold port separate from the discharge port; the outlet manifold port being arranged to recover the reagent leaving the reagent circuit via an outlet passage which brings the outlet manifold port into fluidic communication with the discharge port; the vertical usage position of the plate defining a vertical longitudinal direction between an upper edge and a lower edge of the plate; the discharge port extending in a vertical longitudinal direction between an upper end and a lower end; the vertical plane comprising a first axis extending in the vertical longitudinal direction and passing through half the largest width of the outlet manifold port, the width being measured in the vertical plane and in a direction orthogonal to the first axis; the vertical plane comprising a second axis, orthogonal to the first axis and passing through a tangent at the lower end of the reagent discharge orifice; the outlet manifold port extending in the vertical longitudinal direction between an upper end and a lower end; the outlet manifold port comprising an upper inner edge and a lower inner edge which meet at the second axis; the outlet manifold port comprising, in a section passing through the vertical plane, an upper surface delimited by the upper inner edge and the second axis, and a lower surface delimited by the lower inner edge and the second axis; the lower surface being situated mostly between the reagent circuit and the first axis.

Such a lower inner edge forms a water retention zone near the reagent circuit when the cell is in the usage position. Such an arrangement allows the temperature of the water in the retention zone to be kept high, which allows the temperature of the reactive fluid to be kept high when the reactive fluid (in particular dihydrogen) circulates in the cell. The temperature difference of the reactive fluid between the cell inlet and outlet is thus reduced.

In one embodiment, the outlet manifold port extends in length in the vertical longitudinal direction between the upper end and the lower end, and the outlet manifold port extends in width in a direction orthogonal to the first axis.

As a variant, the outlet manifold port extends in width in the vertical longitudinal direction between the upper end and the lower end, and the outlet manifold port extends in length in a direction orthogonal to the first axis.

According to one embodiment, at least 60% of the lower surface lies between the reagent circuit and the first axis.

According to one embodiment, the lower surface is equal to at least 20% of the upper surface.

According to one embodiment, the discharge port, the outlet manifold port, the reagent inlet manifold port and the reagent distribution port are each formed by a hole through the plate.

According to one embodiment, the outlet passage comprises a plurality of outlet ducts for the circulation of reactive fluid, the outlet ducts each opening via a first end into the reagent outlet manifold, in particular in the upper inner edge of the reagent outlet manifold, and via a second end into the reagent discharge port.

According to one embodiment, at least one of the outlet ducts is longer than another of the outlet ducts, the outlet ducts extending in particular in a direction orthogonal to the vertical longitudinal direction.

According to one embodiment, the lower inner edge of the reagent outlet manifold has no opening into any of the ducts.

According to one embodiment, the lower inner edge of the reagent outlet manifold and the upper inner edge of the reagent outlet manifold meet at the second axis.

According to one embodiment, the lower surface delimits a maximum volume for a water retention zone when the cell is in a usage position.

According to one embodiment, the lower surface is arranged so as to allow the cell to receive the maximum quantity of water expected between two purges under the least favorable operating conditions of the cell.

According to one embodiment, the purge is performed by a temporary increase in the flow of reactive fluid, in particular an increase by a factor between 1.3 and 2 times the nominal flow for a duration of around 0.5 to 2 seconds in order to expel the liquid water accumulated in the retention zone.

According to one embodiment, the lower inner edge of the outlet manifold port comprises a first rounding at its lower end and an inclined rectilinear portion extending in a direction intersecting the first axis so as to form a slope for the flow of water in the direction of the first rounding.

According to one embodiment, the upper inner edge of the outlet manifold port comprises a second rounding; in particular, the centre thereof lies on the first axis.

According to one embodiment, the centre of the first rounding and the centre of the second rounding are offset in a direction parallel to the second axis.

According to one embodiment, the plate comprises a first transverse strip, a second transverse strip, an upper strip on the side of the upper edge, a lower strip on the side of the lower edge, the reagent circuit being arranged in a central part of the plate between the upper strip, the lower strip, the first transverse strip and the second transverse strip.

According to one embodiment, the reagent outlet manifold port is arranged in the first transverse strip, and the reagent inlet manifold port is arranged in the second transverse strip.

According to one embodiment, the plate comprises a cooling fluid inlet manifold formed through the plate and arranged in the upper strip.

According to one embodiment, the plate comprises a cooling fluid outlet manifold formed through the plate and arranged in the lower strip.

The invention also concerns a cell module for a fuel cell, in particular for a proton-exchange membrane fuel cell, the cell module comprising two plates as described above and an Electrode Membrane Assembly sandwiched between the plates.

According to one embodiment, one of the two plates is an anodic plate and the other of the two plates is a cathodic plate.

According to one embodiment, a seal is arranged around the reagent circuit.

According to one embodiment, the lower surface is situated mostly between the seal and the first axis.

The invention also concerns a fuel cell, in particular with a proton-exchange membrane, comprising a stack of cell modules as described above.

According to one embodiment, the anodic plate of one of the cell modules is fixed, in particular glued or welded, to the cathodic plate of another of the cell modules, thus forming a bipolar plate.

As a variant, the anodic plate of one of the cell modules is clamped against the cathodic plate of another of the cell modules, with the interposition of a seal in order to form the cooling circuit.

### BRIEF DESCRIPTION OF THE DRAWINGS

The invention will be understood better from reading the following description and from studying the accompanying figures. These figures are given only to illustrate, and in no way to limit, the invention.

FIG. 1 is a schematic representation, in elevation, of a plate according to the invention;

FIG. 2 is a schematic, partial representation of a detail of the plate from FIG. 1; and

FIG. 3 shows a perspective, schematic and partial view of a stack of plates forming a cell module of a fuel cell according to the invention.

### DETAILED DESCRIPTION OF THE INVENTION

Those elements which are identical, similar or analogous keep the same reference from one figure to the next.

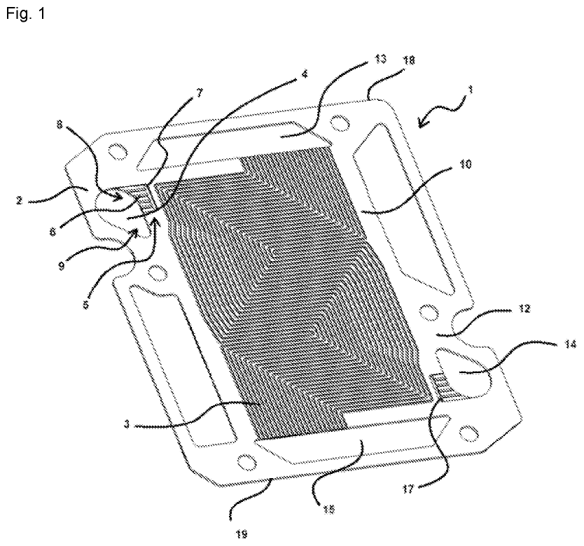

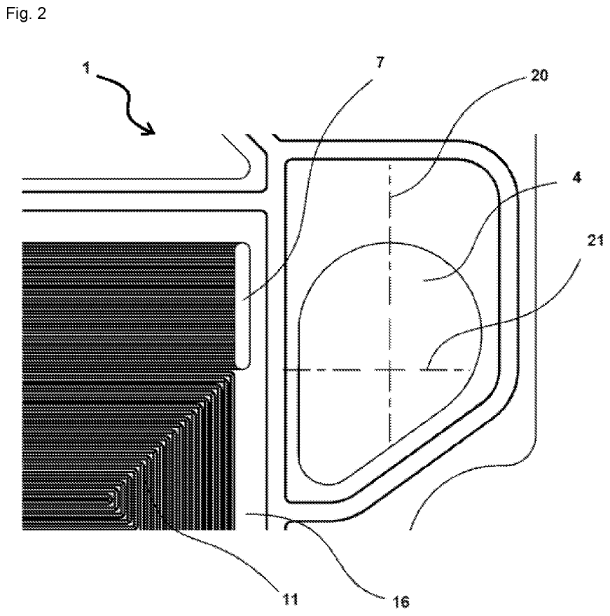

FIG. 1 and FIG. 2 show a plate 1 for a fuel cell of the proton-exchange membrane type. This plate 1 is arranged in a vertical plane when in the usage position.

The plate 1 comprises a reactive face 16 and a cooling face 10 opposite one another (in FIG. 1, the cooling face 10 is shown and the reactive face opposite the cooling face is not visible). The reactive face 16 (shown on FIG. 2) is intended to face an Electrode Membrane Assembly and is equipped with reliefs and recesses forming a reagent circuit 11 for circulation of a reactive fluid.

The cooling face 10 is intended to face the cooling face of the another plate of a stack of plates of the cell, defining between them reliefs and recesses to form a cooling circuit 3 for the circulation of a cooling fluid.

The reagent circuit 11 comprises an inlet opening into a reagent distribution port 17. The plate 1 comprises a reagent inlet manifold port 14 which is separate from the reagent distribution port 17. The reagent inlet manifold port 14 is designed to supply reagent to the inlet of the reagent circuit 11 via an inlet passage which brings the reagent inlet manifold port 14 into fluidic communication with the reagent distribution port 17.

The reagent circuit 11 comprises an outlet opening into a reagent discharge port 7. The plate 1 comprises a reagent outlet manifold port 4 which is separate from the reagent discharge port 7. The outlet manifold port 4 is designed to recover reagent leaving the reagent circuit 11 via an outlet passage 5 which brings the outlet manifold port 4 into fluidic communication with the discharge port 7.

The vertical usage position of the plate defines a vertical longitudinal direction between an upper edge 18 and a lower edge 19 of the plate 1.

The discharge port 7 extends in the vertical longitudinal direction between an upper end and a lower end.

As shown in FIG. 2, the vertical plane comprises a first axis 20 extending in the vertical longitudinal direction and passing through half of the greatest width of the outlet manifold port 4, the width being measured in the vertical plane and in a direction orthogonal to the first axis 20.

The term “width” is used above to indicate the dimension measured in the vertical plane and in the direction orthogonal to the first axis 20. The term does not indicate the relative sizes of the outlet manifold port 4 (length and width).

Also, the vertical plane comprises a second axis 21 orthogonal to the first axis 20 and passing through a tangent at the lower end of the reagent discharge port 7.

The outlet manifold port 4 extends in the vertical longitudinal direction between an upper end and a lower end. The outlet manifold port 4 comprises an upper inner edge 8 and a lower inner edge 9 which meet at the second axis 21 and define, in a section passing through the vertical plane, an upper surface delimited by the upper inner edge 8 and the second axis 21, and a lower surface delimited by the lower inner edge 9 and the second axis 21.

The lower surface is situated mostly between the reagent circuit 11 and the first axis 20.

The discharge port 7, the outlet manifold port 4, the reagent inlet manifold port 14 and the reagent distribution port 17 are each formed by a hole through the plate 1.

As shown in FIG. 1, the outlet passage 5 comprises a plurality of outlet ducts 6 for the circulation of reactive fluid, the outlet ducts 6 each opening via a first end into the reagent outlet manifold 4, in particular in the upper inner edge 8 of the reagent outlet manifold 4, and via a second end into the reagent discharge port 7.

At least one of the outlet ducts 6 is longer than another of the outlet ducts 6. The outlet ducts 6 extend in a direction orthogonal to the vertical longitudinal direction.

The lower inner edge 9 of the outlet manifold port 4 comprises a first rounding at its lower end and an inclined rectilinear portion extending in a direction intersecting the first axis 20 so as to form a slope for the flow of water in the direction of the first rounding.

At least one of the outlet ducts 6 opens into the first rounding.

The upper inner edge 8 of the outlet manifold port 4 comprises a straight rectilinear portion extending in the vertical longitudinal direction. At least one of the outlet ducts 6 opens into the straight rectilinear portion.

The plate 1 comprises a first transverse strip 2, a second transverse strip 12, an upper strip on the side of the upper edge 18, a lower strip on the side of the lower edge 19, the reagent circuit 11 being arranged in a central part of the plate 1 between the upper strip, the lower strip, the first transverse strip 2 and the second transverse strip 12.

The reagent outlet manifold port 4 is arranged in the first transverse strip 2. The reagent inlet manifold port 14 is arranged in the second transverse strip 12.

The plate 1 comprises a cooling fluid inlet manifold 13 formed through the plate 1 and arranged in the upper strip. The plate comprises a cooling fluid outlet manifold 15 formed through the plate 1 and arranged in the lower strip.

The cooling fluid arriving through the cooling fluid inlet manifold 13 enters the cooling circuit 3. In fact the cooling face 10 is here fitted with reliefs and recesses to form the cooling circuit. The cooling face 10 of a plate 1 is intended to face the cooling face 10 of another plate 1 so as to form the cooling circuit. In practice, the reliefs and recesses may be arranged on one or the other or on both plates.

FIG. 2 shows a portion of the plate 1 from FIG. 1, but the visible face is the reactive face 16 which is equipped with reliefs and recesses forming a reagent circuit 11.

The lower surface delimits a maximum volume for a water retention zone when the cell is in a usage position.

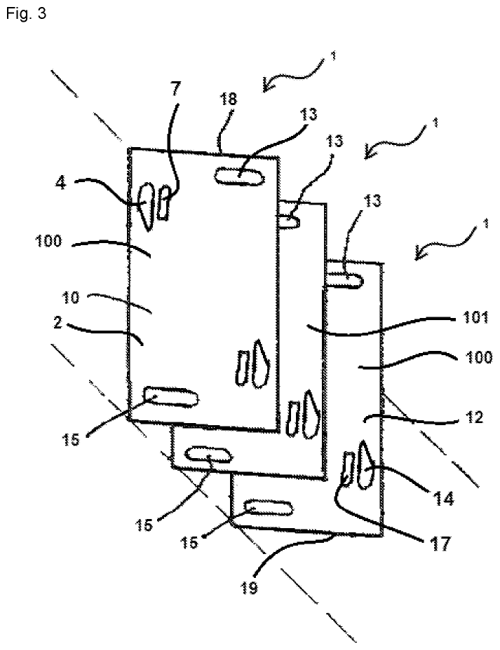

FIG. 3 shows a perspective, schematic and partial view of a stack of three plates 1, namely an anodic plate 101 and two cathodic plates 100.

A cell module for a fuel cell comprises two plates 1 and an Electrode Membrane Assembly (not shown) sandwiched between the two plates 1.

One of the two plates 1 of the cell module is an anodic plate 101 and the other of the two plates of the cell module is a cathodic plate 100.

As shown in FIG. 3, a third plate (here a cathodic plate 100) belongs to a second cell module of the cell (here forming a half cell module, since the second cell module is only partially shown on FIG. 3).

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise. “Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-10. (canceled)

11. A plate for a fuel cell of the proton-exchange membrane type, the plate being arranged in a vertical plane when in a usage position; the plate comprising:
a reactive face and a cooling face opposite one another; the reactive face being configured to face an Electrode Membrane Assembly and being equipped with reliefs and recesses forming a reagent circuit that is configured to circulate a reactive fluid; the reagent circuit comprising an inlet which opens into a reagent distribution port;
a reagent inlet manifold port separate from the reagent distribution port; the reagent inlet manifold port being arranged to supply reagent to the inlet of the reagent circuit via an inlet passage which brings the reagent inlet manifold port into fluidic communication with the reagent distribution port;
wherein the reagent circuit comprises an outlet which opens into a reagent discharge port;
a reagent outlet manifold port separate from the discharge port; the outlet manifold port being arranged to recover the reagent leaving the reagent circuit via an outlet passage which brings the outlet manifold port into fluidic communication with the discharge port;
wherein the vertical usage position of the plate defines a vertical longitudinal direction between an upper edge and a lower edge of the plate;
wherein the discharge port extends in a vertical longitudinal direction between an upper end and a lower end;
wherein the vertical plane comprises a first axis extending in the vertical longitudinal direction and passing through half the largest width of the outlet manifold port, the width being measured in the vertical plane and in a direction orthogonal to the first axis; the vertical plane further comprising a second axis, orthogonal to the first axis and passing through a tangent to the lower end of the reagent discharge orifice;
wherein the outlet manifold port extends in the vertical longitudinal direction between an upper end and a lower end; the outlet manifold port comprising an upper inner edge and a lower inner edge which meet at the second axis; the outlet manifold port comprising, in a section passing through the vertical plane, an upper surface delimited by the upper inner edge and the second axis and a lower surface delimited by the lower inner edge and the second axis;
wherein the lower surface is situated mostly between the reagent circuit and the first axis.

12. The plate as claimed in claim 11, wherein the discharge port, the outlet manifold port, the reagent inlet manifold port and the reagent distribution port are each formed by a hole through the plate.

13. The plate as claimed in claim 11, wherein the outlet passage comprises a plurality of outlet ducts for the circulation of reactive fluid, the outlet ducts each opening via a first end into the reagent outlet manifold, in particular in the upper inner edge of the reagent outlet manifold, and via a second end into the reagent discharge port.

14. The plate as claimed in claim 13, wherein at least one of the outlet ducts is longer than another the outlet ducts, the outlet ducts extending in particular in a direction orthogonal to the vertical longitudinal direction.

15. The plate as claimed in claim 11, wherein the lower inner edge of the outlet manifold port comprises a first rounding at its lower end and an inclined rectilinear portion extending in a direction intersecting the first axis so as to form a slope for the flow of water in the direction of the first rounding.

16. The plate as claimed in claim 11, wherein the plate comprises a first transverse strip, a second transverse strip, an upper strip on the side of the upper edge, a lower strip on the side of the lower edge, the reagent circuit being arranged in a central part of the plate between the upper strip, the lower strip, the first transverse strip and the second transverse strip.

17. The plate as claimed in claim 16, wherein the reagent outlet manifold port is arranged in the first transverse strip, and the reagent inlet manifold port is arranged in the second transverse strip.

18. The plate as claimed in claim 17, wherein the plate comprises a cooling fluid inlet manifold formed through the plate and arranged in the upper strip, and the plate comprises a cooling fluid outlet manifold formed through the plate and arranged in the lower strip.

19. A cell module for a fuel cell, wherein the fuel cell is a proton-exchange membrane fuel cell, the cell module comprising two plates as claimed claim 11 and an Electrode Membrane Assembly sandwiched between the plates.

20. A fuel cell comprising a stack of cell modules as claimed in claim 19.
